(19) United States
(12) Patent Application Publication
(10) Pub. No.: US 2011/0305555 A1
(43) Pub. Date: Dec. 15, 2011

(54) Isentropic method and apparatus for greatly increasing and extracting the power from wind and moving air

(76) Inventor: Bernard Allan Power, Dorval (CA)

(21) Appl. No.: 13/068,902

(22) Filed: May 24, 2011

Related U.S. Application Data
(60) Provisional application No. 61/397,312, filed on Jun. 10, 2010.

(51) Int. Cl. F03D 11/00; F01D 25/24

(52) U.S. Cl. 415/1; 415/182.1

(57) ABSTRACT

This invention employs the isentropic acceleration of a basic air flow, supplied by the wind, through a converging/diverging De Laval Nozzle, to thereby enormously increase the air flow speed and power at the nozzle throat section and to simultaneously lower the pressure there to approximately one-half of ambient pressure. This low throat pressure is then used as a ‘vacuum’ source to activate a high speed isentropic flow of air through a power take-off means consisting of a flow rotor which converts the energy of the accelerating linear air flow through it into rotational energy suitable for take-off to do useful external work at very low cost. The invention can also be mounted on a moving vehicle so that the relative air flow past the vehicle supplies the air flow to produce the high power output at very low cost.

### CROSS REFERENCES TO RELATED APPLICATIONS

On Jun. 2, 2010 a U.S. Provisional Patent Application 61/397,312, Confirmation NO. 3616 entitled “An Isentropic Method for Economically Greatly Increasing the Power from the Wind and Air” was filed. Applicant and Sole Inventor Bernard A. Power. (The present Utility patent application succeeds said Provisional Patent Application of Jun. 2, 2010).

In a previous U.S. Utility patent application Ser. No. 12/927,830. Filing Date Nov. 26, 2010. Confirmation No. 1124., entitled: “Method and apparatus for efficiently generating and extracting power from an air flow to do useful work”: a new air motor was disclosed which could be powered by a vacuum source, by a compression source, by the wind, etc. The present application discloses a particular method and apparatus for first increasing the power of the wind through an apparatus and then using the previously disclosed air motor as a power take-off means to use a portion of the increased power to do useful work.

### BACKGROUND TO THE INVENTION

The extraction of useful power from the wind is increasingly important to a world in need of economical, renewable, clean and environmentally “friendly” energy sources. Still, the economics and efficiencies of the windmill art remain deficient or have reached various limits. Wind power is at the present time still relatively expensive because of the high cost of the large propellers and large supporting structures required to produce reasonably large amounts of power, while at the same time the low wind strengths and variability of the wind energy input have been beyond human control.

Setting up an air flow so as to then use its kinetic energy to do useful work is commonly done by using either a vacuum or “pull flow” source, or by a using a compression or “push flow” source. Here I disclose a new method and apparatus for a vacuum flow air energy source that uses the atmospheric wind as its basic mass flow source, and moreover does so in a novel and far more efficient manner than existing prior art.

The power in the wind approaching a windmill can be computed [Ref.1] by the formula:

P=½(ρVA)V² (1)

where ρ is the air density, V is its velocity and A is the cross-sectional area of the intercepted air flow.

For a windmill, having a propeller diameter D=2R, this becomes the engineering formula

P=½ρ(πR²)V³=½ρ(πD²/4)V³ (2)

If ρ, V, A and R are in SI units (kilogram, meter, second) then the power P in Equations 1 and 2 will be in watts.

Noting that ρVA is the mass rate of flow (m-dot=dm/dt=ρVA) where m-dot is in kilograms per second, we can rewrite the power equation 1 as

P=½(m-dot)V² (3)

From this we see that if the mass rate of flow is employed then the power that can be obtained from a windmill is equal to the product of the mass rate of flow and the average wind velocity squared. In practice, since the average wind speed at a particular site is a given and uncontrollable quantity, this means that we can only increase a windmill's power by increasing the mass flow rate and that requires intercepting a larger and larger mass of air, which in turn means using larger and larger diameters for the windmill propellers, making the present windmills very expensive for reasonably large power outputs.

Currently, the cost of production of power from the wind is higher than hydroelectric power, nuclear power or power from fossil-fuel fired gas turbines.

To repeat, the two current major limiting factors in wind power production are, first, the large and costly propellers and associated large support structures to intercept a reasonably large mass flow of air, and, second, the generally low average wind speeds prevailing at most accessible windmill sites, and therefore the low kinetic energy of air flow available to the windmill propeller blades.

### BRIEF SUMMARY OF THE INVENTION

In the present invention, I disclose a method for greatly accelerating the air flow through the apparatus, and thereby greatly increasing the available kinetic energy of flow and the power available for useful work. This increase of power is accomplished by an isentropic acceleration [Ref. 2, 3, 4] of the air flow.

My invention employs the basis mass flow of air set up by the wind, and then greatly increases its kinetic energy. Since a basic ingredient is a moving stream of air, the invention applies also to an embodiment in which the basic moving stream of air is supplied by, say, the relative air flow past a moving vehicular platform, such as an automobile, train, ship or airplane, etc,. on which the invention apparatus is mounted. In a preferred embodiment, my invention employs converging and diverging nozzles to accelerate and then decelerate the air flow efficiently, such a system being commonly described as a De Laval Nozzle.

The invention will now be briefly described in a preferred embodiment as follows: An apparatus for greatly increasing the power of a flow of air from the wind consisting of a De Laval Nozzle, said nozzle having an inlet converging cone and an exit diverging cone attached together at their minimum cross-sections to form said De Laval Nozzle's throat section, said nozzle being kept pointed into the wind or air flow by a vane or other orienting means, said air flow setting up a fixed mass flow of air through said De Laval Nozzle, which mass flow is proportional to the prevailing average wind speed; said flow of air through said nozzle increasing in speed through said converging nozzle section to reach near sonic speed of 313 m/s in said nozzle's minimum or throat section, said sonic flow then decelerating efficiently and isentropically in said diverging cone section to reach ambient wind speed and pressure at the said diverging nozzle exit Said increased air flow power being accessed or tapped into immediately downstream of said nozzle's throat section by a flow port leading to a rotating power take-off means.

### BRIEF DESCRIPTION OF THE DRAWING

FIG. 1 shows the an embodiment of the apparatus, consisting of converging and diverging cones 1 and 2 of a De Laval Nozzle, said cones being connected together to form a nozzle throat 3, said throat having a bleed port or power take-off access port 4 connected to a rotating power take-off means 5. The flow power port 4 immediately downstream of the throat 3 of the De Laval Nozzle allows access to the low pressure area in the nozzle throat 3; the pressure gradient between said low pressure in the throat area and the ambient pressure in the inlet to the power take-off means 5, draws air in through a rotor of said power take-off means, the air accelerates in said rotor and the reaction force to the acceleration rotates said rotor for doing useful work.

### DETAILED DESCRIPTION OF THE INVENTION IN A PREFERRED EMBODIMENT

In my invention, the current disadvantages of conventional windmill low power production from low wind speeds are overcome in an entirely novel manner. I first pass a mass flow of air powered by the wind through a properly designed De Laval Nozzle [Ref 3,4]]. The mass flow of air is first accelerated in the converging or entry conical section of the nozzle efficiently and isentropically to near sonic speed at the nozzle throat section; it is then decelerated efficiently and isentropically through the diverging or exit nozzle back down to ambient wind speed and up to ambient air pressure at the nozzle exit. I then extract a portion of the vastly increased flow energy and power immediately downstream of the nozzle throat by a rotating power take-off means to do useful work.

It is pointed out that in any air flow apparatus the two basic physical elements are, first, the mass flow of air through the apparatus that sustains the flow speed and power and, second, the pressure differential between entrance and exit to the apparatus that initiates and sustains the mass flow. The pressure differential is the difference in static pressure between the entrance to the apparatus and the exit from the device; it does not concern any of the various pressure differences which may occur within the flow device after entrance and before exit. For low air speeds (less than about Mach 0.3) the Bernoulli equation for incompressible flow will suffice to determine the pressure differential and flow velocities. For higher speeds, the isentropic flow relations must be used. These various flow equations will all be discussed later in this specification.

The main elements in my invention can be conveniently discussed under four headings or groups. First, there is a basic mass flow of air supplied by the wind, second, the velocity of this basic mass flow is greatly accelerated efficiently to near sonic speed at the nozzle's narrowest cross-sectional area or “throat” to increase its kinetic energy and power, third, the higher speed flow is then decelerated efficiently back down to lower speed and exit ambient pressure to preserve the basic mass flow through the apparatus, and fourth the increased energy and power associated with the high speed flow at the throat is efficiently used by a rotating power take-off means attached immediately downstream of the nozzle throat by a vacuum pressure take-off port to do useful work. We now examine each of these elements in turn.

(1). The first element of the present invention, the basic mass flow, is supplied by the wind or by a relative flow of air moving past a vehicular platform upon which the apparatus of the invention is mounted. The mass flow has following formula:

ρ₁V₁A₁=ρ₂V₂A₂=dm/dt=m-dot=constant

A basic mass flow may be set up in a fluid in several ways: first, a vacuum source may be used to “pull” the air through the apparatus, second, an air compressor maybe used to “push” the air flow through the apparatus, third, as in the present invention, an air flow such as the wind or the air blowing past a moving vehicle may be entrained into and through the apparatus.

In connection with maintaining a given mass flow, it will be well to point out that any flow of air from whatever source through an apparatus will involve the pressure difference across the apparatus from inlet to outlet; it is this pressure difference which drives and maintains the mass flow. In the case of a vacuum pump flow source, the pressure difference will be that between the ambient pressure at the inlet to the apparatus and the vacuum pressure maintained at the vacuum pump. In the case of a compressor, it will be the difference between the compressor exit pressure and the ambient pressure at the apparatus flow exit port. In the case where the source of the mass flow is the wind, the pressure differences across the apparatus from entrance to exit are very much smaller, being just the dynamic or flow pressure of the air, p=½ρV². For example, a wind speed of 10 m/s will have a dynamic pressure of p=½1.2×10²=60 Pascals or 0.6 millibars. This is therefore the pressure differential across the apparatus from entrance port to exit port in a wind of 10 m/s that must be maintained in order to maintain the mass flow through the apparatus. Inefficiencies in the flow through the apparatus such as turbulence and friction will lower the flow speed, pressure differential, mass flow and power of the flow through the apparatus.

Since the wind pressure differences are relatively small, care must be taken to ensure that the De Laval nozzles employed to accelerate the flow also decelerate the exiting air flow through the diverging section to the atmosphere properly and efficiently without significant turbulence or other heat energy dissipation losses i.e. to return the air to the ambient atmospheric pressure, temperature and wind speed prevailing at the nozzle exit, otherwise mass flow will drop and power will be lost.

(2) The second element of the invention, namely that of accelerating the mass air flow to high speeds near the sonic limit at the nozzle throat, can be achieved by decreasing the cross-sectional area of the flow duct as in the converging section of a De Laval nozzle. This flow accelerating process is an isentropic one with no heat flowing into or out of the mass air flow [Ref. 2,3,4].

(3) The third element in the invention, namely that of decelerating the high speed, low pressure air at the throat of the nozzle back to low speed and ambient pressure at the apparatus flow exit port, is accomplished in the De Laval nozzle's diverging section as is well known to those versed in the art. This deceleration flow process is also an isentropic one, and is more difficult to achieve efficiently, that is without losses, than the acceleration process [Ref. 2].

(4) The fourth element in the invention, namely the efficient extraction of the increased airflow kinetic energy and power may be achieved in various ways, such as for example with an air turbine, a propeller, and so on. In a preferred embodiment of this invention to be described below, the power is extracted by a reaction rotor [Ref 5] in which the low pressure at the De Laval Nozzle throat is used to draw in a mass flow of air through the power take-off rotor, accelerate it to sonic speed and use the acceleration thrust forces to rotate the rotor and do useful work.

### Isentropic Flow in a Converging/Diverging De Laval Nozzle

In order to properly design the converging/diverging De Laval nozzle which acts to accelerate the basic mass flow of air to high speed and supplies the necessary elements two and three of the invention discussed above, it is necessary to use the formulae for isentropic flow which will now be briefly described.

The general subject of air flow is a part of fluid mechanics [Ref. 2], which deals with both incompressible and compressible flows. Air is compressible, so that its density is not constant but varies with the flow speed V, the pressure p and the temperature T. The changes in air density ρ with flow speed are quite small up to speeds of about Mach 0.3 (about 90 m/s), so that for low wind speeds, air is often treated as being incompressible with the density ρ being taken as constant (at about 1.2 kg per cu. m. at m.s.l.). For the low speed incompressible case, the two principal flow equations are the Bernoulli equation and the equation of mass continuity which are as follows:

First, the Bernoulli equation which is related to the energy, is

∫dp/ρ+½V²=constant along a streamline (4)

For incompressible flow, this becomes

p/ρ+½V²=constant along a streamline in energy units (4a)

or p+½ρV²=constant along a stream line in pressure units (4c).

The second flow equation is the Equation of Continuity of Mass

ρ₁V₁A₁=ρ₂V₂A₂=dm/dt=m-dot=constant (5)

where the subscript numerals refer to values of the density ρ, velocity V and cross-sectional area A at different cross sections along the flow path.

It is seen that Equation (5) represents the mass m of air flowing per second (dm/dt), which in SI units would be expressed as kilograms of air passing through any given area per second. Thus, a reduced cross-sectional area A, means an increased velocity V and vice versa. The velocity increase in a flow passing through a converging conical nozzle can be formulated as

V₂=V₁[A₁/A₂][ρhd 1/ρ₂] (6)

From this we can see that, if the air density ρ were to be constant, the velocity increase in a converging nozzle is inversely proportional to the cross-sectional area decrease. This simplifying constant density assumption could apply for example to air speeds of about Mach 0.3 (90 m/s). Above that speed, the decrease in density with increasing velocity becomes important for compressible fluids and must be explicitly be taken into account through the isentropic relationships.

The special type of acceleration in flow velocity in which we are interested in this invention has no heat flow in or out of the system; it is called isentropic flow. This type of flow comes about from imposing some restriction to the area through which a compressible flow moves.—such as through a converging nozzle, or from entrainment of the flow into a vortex in which the centrifugal force and curved flow streamlines cause an acceleration and a velocity increase. In an isentropic process no heat is added or extracted and the entropy remains constant.

In an isentropic flow [Ref. 2,3,4] the changes in the thermodynamic variables of the gas, i.e. in the pressure p, density ρ, temperature T, speed of sound c, and flow velocity V, all take place according to the isentropic relationships:

(p/pₒ)^{(k-1)/k}=(ρ/ρₒ)^{k-1}=T/Tₒ(c/cₒ)²=1−1/n(V/cₒ)² (7)

where n=2/(k−1) and k=cₚ/cᵥ the ratio of specific heats. Expressed in terms of the number of ways n that the energy is divided (n=2/(k−1)) we also have

(p/pₒ)^{2/n+2}=ρ/ρₒ)^{2/n-1}=T/Tₒ(c/cₒ)²=[1−1/n(V/cₒ)²] (7a)

Thus, for example, a drop in any one of pressure, density or temperature brings about an increase in the flow velocity, all without any work being done. The subscripted values are for stagnation or zero velocity initial conditions. For air, the value of k, the ratio of specific heats (k=cₚ/cᵥ), has the value 1.4. Here c is the speed of sound and cₒ is its stagnation (no flow) speed.

Isentropic velocity increases readily take place, for example, in a converging nozzle through which the flow is directed; the velocity reaches its maximum value at the narrowest cross-section of the nozzle. If the flow is then passed on through a diverging nozzle it will isentropically decelerate and drop back to normal velocity, pressure and density value at the exit. The governing equations for compressible flow of air in a nozzle are the isentropic flow relationships as given in Eqns.7 and 7a plus the equation of continuity of mass in Eqn.5.

A given mass flow, for example 1 kg of air per second, passing through a converging nozzle, will have its flow velocity V increased as required by the equation of mass continuity, Equation 5, to keep the value of the mass flow constant, while at the same time the cross-sectional area A of the duct at each point along the duct decreases proportionally to bring about the velocity increase.

The flow speed can continue to increase through a suitably dimensioned converging nozzle until it reaches the sonic speed c* (about 313 m/s at sea level) at the minimum cross-sectional area of the nozzle or ‘throat’, at which limiting velocity the flow physically “chokes” or stops increasing in velocity. At this sonic flow speed of about 313 m/s, the pressure will have dropped by 47.2% to almost half an atmosphere, the density will have dropped by 37% and the temperature by 17%, while the air flow power will have greatly increased.

We can see this more clearly from Table 1 where the throat area and diameter needed to pass various mass flows at sonic speed are listed:

TABLE 1
Minimum Throat Size Needed to Pass
Various Mass Flows At Sonic Speed

| Mass | | Throat | | Throat |
|---|---|---|---|---|
| flow (kg/s) | | Diameter (m) | | Area (m²) |
| 1 | kg/s | 0.073 | m | 0.00419 |
| 2 | | 0.102 | | 0.00818 |
| 3 | | 0.126 | | 0.01247 |
| 4 | | 0.146 | | 0.01674 |
| 5 | | 0.164 | | 0.02112 |

To take a specific example, consider a steady wind flow of 1 m/s entering a nozzle having an inlet area of 1 sq. meter. With the air density being about 1.2 kg. per cubic meter at sea level, we would then have from Equation 6 a mass flow rate of ρ₁V₁A₁=1.2×1×1=1.2 kilograms per second, minus any entrance lip losses.

If this mass flow, for example, is passed through a De Laval Nozzle, then at the minimum cross-sectional area or ‘throat’ of the nozzle, the flow speed will have been accelerated to sonic speed, that is to say to 313 m/s. The throat air power then is

P=½m-dot 313²=½×1.2×313²=58781.4 watts=58.8 kw

### Nozzle Design Details

In the case where the mass inflow is powered by the wind, there may also be back pressure losses set up at the exit to the atmosphere if the accelerated sonic flow at the nozzle throat is decelerated inefficiently back down to ambient wind speed. values at the nozzle exit. Such back pressure losses have the effect of reducing the pressure gradient through the nozzle between entrance and exit, thus reducing the flow speed, mass flow and the air power at the throat which is connected to the power take-off means. These losses must be properly reduced in the design for maximum power output. This is accomplished by a nozzle design in which I add a diverging cone at the throat exit to further channel the exiting flow immediately it leaves the high flow speed area at the throat of the converging nozzle. The throat high speed flow is thereby decelerated smoothly and efficiently through the diverging section without inefficient energy losses to friction, turbulence or heat so that the flow recovers from its low pressure/high velocity values at the throat towards the atmospheric pressure and low ambient wind speed values which it must match at the duct exit to avoid the back pressure losses and so to maintain the basic mass flow.

To design an efficient means for using the method of my invention in a particular case, the designer has several options. He can, for instance, first choose the amount of throat air power (that is, the vacuum pressure drop at the throat) that he wishes to produce to feed to the power-take off means. This in turn sets the necessary size of the throat area of the converging cone A*. needed to pass the mass flow through the throat at sonic speed to produce the throat power, which in turn sets the inlet converging nozzle diameter needed, for the prevailing average wind speed inlet flow, to deliver that mass flow rate.

An example may help to clarify the design procedure: First, select a desired throat air flow power, say, 48,984.5 watts. Then, the mass flow matching this at sonic speed is obtained from Equation 3, P=48,984.5=½×m-dot×313², so that m-dot, the mass flow rate equals 1 kg/s. Then from Table 1 we see that a flow of 1 kg/s at sonic speed requires a throat diameter of 0.073 meters. Then we need a wind speed that will deliver 1 kg/s through a converging nozzle. Clearly, this will depend on the wind speed prevailing. For example, an average wind of 1 m/s through a cone with an inlet area of 1 square meter would deliver 1 cubic meter of air per second, and this, with an air density of 1.2 kg per cubic meter, would deliver a flow of 1.2 kg/s. Therefore a 1 kg/s flow would need a wind of 1/1.2=0.83 m/s. Again for a wind speed of 5 m/s the mass flow of 1 kg/s will require a nozzle having an inlet area of ⅕×0.83=0.166 sq. m. Or, an average wind speed of 10 m/s would need one tenth of a square meter inlet area times 0.83 or 0.083 sq. m. to maintain the selected mass flow of 1 kg/s. Since the wind speed is never constant we see that some variation in actual mass flow and throat power will be inevitable.

The designer could of course also proceed by first choosing, say, the throat diameter instead of the throat air power, for example a diameter of 0.073 m. This at once sets the throat mass flow from the equation of continuity at:

m-dot=ρ*V*A*=[1.2×0.063394×π×(0.073/2)²=1 kg/s as before.

and the throat air power at sonic speed is again

P=½×m-do×313²=½×ρ*V*A*=48,984.5 watts

Then, as before, the mass flow sets the inlet cone diameter from the average wind speed and the equation of mass continuity.

Then, for any wind V₁ bringing in a mass flow (ρVA)₁ through the converging cone of 1 kg/s, a throat air flow power of 48.9845 kw will be produced at sonic speed. Less wind input will produce less power; a higher average wind than the selected design speed will exceed the design mass flow rate that can be passed through the throat and the flow will ‘choke’ or stop increasing, and the throat air power will remain constant at 48.984 kw.

To design for a higher average input wind speed V₁, the designer will need to increase the throat area A* to accommodate the higher average mass flow rate m-dot=ρ₁ V₁A₁; this increase in mass flow rate will then increase the output power available. The flow rate can also be increased by increasing the size of the inlet area A₁, and this will then also require an increase in the throat area A* to accommodate the increased mass flow rate; other design options can be worked out in similar fashion. The proper design procedures and dimensions for the diverging section of the flow system for each case will be well known to those versed in the art of De Laval nozzle design.

It is, of course, not necessary to let the flow increase to its maximum or sonic speed of 313 m/s, and, if desired, the nozzle can be designed to run at any smaller throat speed. Finally, if the nozzle is designed to pass a mass flow which is less than the flow that the prevailing average wind speed offers for entry to the nozzle for that particular wind speed and nozzle inlet area, then the flow will “choke” or remain constant at the design mass flow rate value. The invention can be operated in this mode if desired, or, as we shall see later, it can be operated so that the vacuum drop available is bled off at the throat and used to induce a subsidiary flow whose energy can be tapped and used in the rotating power take-off means.

Tabulations of isentropic flow values of pressure, temperature, density versus flow Mach number are readily available [Ref. 2, 3] for computations of the isentropic values used in nozzle design. However, the exact isentropic equations for nozzle design are most easily applied by one of various commercially available nozzle design computer programs.

It is also pointed out that, while in this disclosure I have mentioned conical nozzles, that other nozzle shapes, such as parabolic converging and diverging nozzle sections, or Bell nozzles and so on can be employed. These also provide isentropic acceleration at the nozzle throat and are intended to be included in the present disclosure of the invention along with the simple and efficient conical shaped nozzle sections that are used in the described embodiment.

I also point out that all of the throat power is obviously not available for power take-off, since the basic mass flow of air must be maintained through the throat to in turn maintain the sonic speed and energy. The power take-off means will next be described.

### Power Take-Off Means

The fourth element in the invention is the power take-off means for efficiently extracting the high speed flow energy and high power immediately downstream of the nozzle throat to do useful work while maintaining the basic mass flow intact. In the present invention this is done by using the vacuum or ‘suction’ at the throat, which is generated by accelerating the flow, in a novel way.

In the prior art on windmills, a propeller, or flow turbine is positioned directly into the wind flow to extract its low speed power. There is then a deceleration of the wind flow through the propeller, or turbine which results in rotation being imparted to them. The Betz Limit [Ref 1] sets 59.2% as the maximum power that can be extracted from the air by such means. In practice there are also other flow energy losses so that net efficiency of power extraction is typically from 30 to 40%.

In my invention, I first accelerate the wind or air flow many times over at the throat of a De Laval nozzle assembly. However, if one were to employ the same methods of extraction as in an ordinary windmill by inserting a propeller or turbine directly into the accelerated air flow, one would greatly disturb the isentropic flow and reduce the mass flow and the flow power. But, I much more efficiently employ another means of extracting the high speed flow power generated at the nozzle throat, that avoids disrupting the flow. In my method, I insert a power take-off port or ports immediately downstream of the nozzle throat which, when connected to a rotating power take-ff means [Ref. 5], efficiently extract a substantial portion of the throat air flow power without reducing the mass flow below the design value. The vacuum pressure gradient set up between the low pressure in the throat flow (approx 47.5 kPa) and the outside ambient atmospheric pressure (approx. 100 kPa) at the entrance to the take-off port, provides the vacuum pressure gradient or ‘suction’ to set up a subsidiary mass flow of air in though the power take-off rotor. of the apparatus. (At sonic speeds this pressure drop or take-off ‘suction’ is about one half an atmosphere (i.e. 100−47.5=52.5 kPa.).

To see this more clearly the tabulations of Tables 2 to 4 have been prepared:

TABLE 2
Air Power from a Conventional Windmill
and the Present Invention Compared
(For a fixed mass flow of 1 kg/s)

| Wind Speed | Windmill | Invention's Throat |
|---|---|---|
| (m/s) | Air Power (1) | (Sonic) Power (2) |
| 1 | 0.6 watts | 48,945 watts |
| 5 | 12.5 watts | 48,945 watts |
| 10 | 50 watts | 48,945 watts |
| 20 | 200 watts | 48,945 watts |

Notes:
(1) P = ½ × m-dot × V²;
(2) P = ½ × m-dot × 313²

(3) We see that the power is produced by the product of the mass flow and the square of the wind speed through the turbine. The basic mass flow is indeed the same with a windmill and with my invention, but the flow speeds through my invention at the nozzle throat section are many times larger than the wind through a conventional windmill and so the flow power available at the throat is enormously increased. (For a fixed mass flow, the power is proportional to the flow velocity squared).

TABLE 3
Nozzle Dimensions, Potential Throat Air Power (1) and Choked Air Power (2)

| | | | | | | | | | | |
|---|---|---|---|---|---|---|---|---|---|---|
| Wind Speed | 5 | m/s | 10 | m/s | 15 | m/s | 20 | m/s | 25 | m/s |
| Cone Inlet diameter | 46 | cm | 32.6 | cm | 26/6 | m | 23 | cm | 20.6 | cm |
| Potential Mass Flow | 1 | kg/s | 2 | kg/s | 3 | kg/s | 4 | kg/s | 5 | kg/s |
| Throat Power (1) | 49 | kw | 98 | kw | 147 | kw | 196 | kw | 245 | kw |
| Choked Power (2) | 49 | kw | 49 | | 49 | | 49 | | 49 | |

Notes:
(1) Throat Air Power is the power at sonic throat speed when the throat diameter is matched. to accept and pass the mass flow rate available from the wind (P = ½ × mass flow rate × 313²)
(2) Choked power is the Throat Power if throat diameter is held at, say for example, 7.31 cm which can only pass 1 kg/s; therefore for wind speeds greater than 5 m/s, this diameter of 7.31 cm ‘chokes’ or holds the flow constant at 1 kg/s and the power constant at 49 kw. even although the wind speed is great enough to produce increased power. To tap the greater power available with increased wind speed, we can simply enlarge the throat diameter at the take-of port to accept and pass the increased mass flow available from the increased wind speed. (See Table 2).

TABLE 4
Mass Flow Rate and Matching Minimum Nozzle
Throat Diameter Needed to Pass It at Sonic Speed

| Mass | | Matching | | Sonic | |
|---|---|---|---|---|---|
| Flow | | Throat | | Throat Air | |
| Rate | | Diameter | | Power | |
| 1 | kg/s | 7.31 | cm | 49 | kw |
| 2 | | 10.3 | cm | 98 | |
| 3 | | 12.7 | cm | 147 | |
| 4 | | 14.6 | cm | 196 | |
| 5 | | 16.4 | cm | 245 | |

The invention makes an enormous improvement in potential power output versus the prior windmill art. In the prior art, the wind flow power is set by the mass flow and the input wind speed squared. For example, a wind of 5 m/s and a mass flow of 1 kg/s will have an air power of P=½×1×5²=12.5 watts. In contrast, in my invention, the input wind speed is greatly accelerated by the converging cone at the throat and will now have a throat flow speed of 313 m/s instead of the wind speed which is typically around 10 m's on the average. The apparatus in my invention will now have a throat power of ½×1×313²=48,985 watts, which is 3919 times larger than the windmill prior art air power as can be seen from Table 2.

Of course, the throat power is not the actual power that can be extracted by the power take-off means. The extractable power in the present invention has two components. First, only a fraction of the throat power can be bled off at the vacuum pressure take-off ports if the throat mass flow rate is to be kept at or above the sonic flow speed mass flow rate value; the amount of the bleed-off will depend on the “overdesign” value chosen, as described above. Second, the bleed-off vacuum mass flow can not all be converted into usable rotational power by any take-off means. In the case of a windmill propeller take-off, the absolute limit is 59.2% of the flow through the propeller (i.e. the Betz Limit). In the case of the rotor take-off means of the preferred embodiment described in the present Application, [Ref. 5] the take-off power percentage is 50%. However, in the present invention the final power take-off is still hundreds of times larger than the power available from a prior art windmill of the same diameter under the same input wind speed and mass flow condition.

### Design Details and Procedures

To design for a given desired Power and Average Wind Speed. The central fact to note here is that any power take-off will affect the mass flow through the inlet cone, since the flow will partition in proportion to the ratio of the areas of the inlet duct and the power take-off port. In practice it is found easiest to work with and compare the throat areas. If they are equal then they will pass the same flow and the mass flow will partition equally between them. If they are different, the flow will partition in proportion to their area ratio. Therefore, if we open a pressure bleed or take-off port just downstream of the throat and it has the same area as the main nozzle throat then the flow will—if it is nowhere choked—partition equally between the two openings. That is to say, the mass flow through each separate inlet opening, will be one half of the total mass flow passing through the apparatus.

If the flow is choked at the throat section in any duct, the situation is different. Suppose the main cone inlet has its throat area so small that it chokes the flow there. This fixes the total mass flow it can pass. If then a bleed port is opened mass will flow through the bleed port in proportion to the ratio of the two throat areas so long as the flow remains constant at the choked value in the main cone duct. This suggests a design strategy as follows: We “over-design” the main conical duct so that the flow is choked several times over at the throat; this is done by simply making the cone inlet area larger than needed to pass the prevailing wind flow through the throat, thus more mass flow is available than can pass and the flow remains choked, and the throat pressure remains at sonic value even when bleed air is admitted from the power take-off rotor through the bleed port. This can continue until more bleed air is admitted than the choking condition will sustain, at which point the throat flow will drop below sonic speed, the throat pressure will begin to rise, the available vacuum ‘suction’ will drop, and the power take-off limit has been reached.

For example, suppose we wish a net power output of 49 kw for a site with an average wind speed of 5 m/s. Assuming an efficiency of power take-off of 50%, we would then need to design for double the power to compensate for the take-off losses. But if we were to design for that exact value then when we do take off any power the throat speed of the mass flow will drop below sonic and the power will drop.

So, to compensate for this, we “over-design” as follows: We take, for example, 4×49−=196 kw as the available wind power needed at the throat. Then from Table 4 we see that this will require a mass flow of 4 kg/s and for a site with an average wind of 5 m/s this will require an inlet cone with inlet diameter of 0.65 m. But we actually keep the throat size at only 0.7321 m which will only pass 49 kw. This means that under average wind speeds the nozzle will have a potential for 196 kw but the flow will “choke” and the apparatus will only actually pass 49 kw through the throat. However, if we now draw off flow and power from the choked power at the throat, we will still have lots of power in reserve and so will continue to have sonic speed and 49 kw at the throat while we take off 49 kw of power to the outside for useful work, since we have over-designed to allow for 50% loss. This cone design will deliver 49 kw of take off power and the flow will have enough built in reserve of potential mass flow that the flow will still remain sonic at the throat while the power is taken off. See Tables 3 and 4 above, and Table 5 below.

TABLE 5
Mass Flow and Air Power versus Cone Inlet Diameter

| | | | | | Cone Inlet Diameter | | | | | |
|---|---|---|---|---|---|---|---|---|---|---|
| Mass | | Throat | Air | | at Various Wind Speeds | | | | | |
| flow | | Size | Power | | 5 m/s | | 10 mm/s | | 20 m/s | |
| 1 | kg/s | 0.731 m | 49 | kw | 0.46 | m | 0.33 | m | 0.23 | m |
| 2 | | | 98 | | 0.64 | | 0.46 | | 0.33 | |
| 3 | | | 147 | | 0.80 | | 0.56 | | 0.40 | |
| 4 | | | 196 | | 0.92 | | 0.65 | | 0.46 | |
| 5 | | | 245 | | 1.03 | | 0.73 | | 0.51 | |

In the case of a conventional wind mill, if we should want to design for four times the power we must quadruple the propeller swept area, that is to say we must increase the propeller diameter by twice. We do essentially the same thing here, but in the case of the windmill the scaling up costs of enlarged apparatus for the increased power are very large, but in the case of the present invention, with its great acceleration in the flow rate through the converging entry nozzle, we get so much power from much smaller dimensions that the scaling up cost for the cones to deliver the additional flow rate and power becomes a trivial matter by comparison.

To sum up, we over design the inflow so that even when power is being drawn out of the vacuum at the throat, the basic mass flow through the throat will remain choked at sonic speed and sonic vacuum pressure.

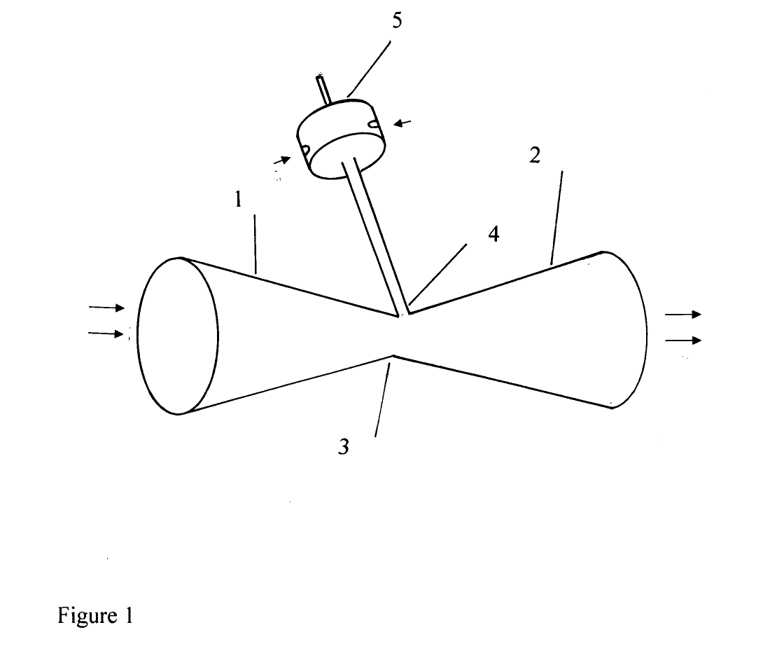

The invention is now further described in a preferred embodiment with reference to FIG. 1. Into a given flow of wind having speed V, I insert a De Laval nozzle whose converging section 1 and diverging section 2 are joined at a nozzle throat section 3. The incoming wind flow enters said converging nozzle 1 of entry diameter A₁, and then flows through the nozzle at continual decrease of cross-sectional area, to the minimum cross section or throat section 3, while simultaneously increasing its flow velocity according to the mass continuity requirement as the nozzle cross-sectional area decreases along the axis of the nozzle from its larger entry to its smallest cross-sectional area at the throat. (If so designed, in a converging nozzle having suitable input entry speed and suitable entry and throat area ratio the said wind flow velocity in the nozzle can reach sonic speed at the throat (313 m/s or about 700 mph) A suitable diverging exit flow nozzle 2 is used to properly decelerate the high speed sonic flow as efficiently as possible from its high speed at the throat down to ambient wind speed at the exit without unwanted and wasteful pressure gradient losses. The dimensions of the De Laval nozzle converging cone and diverging cone are best calculated by using a computerized nozzle design program which efficiently uses the isentropic equations for compressible high speed flow. Immediately downstream of the throat section 3 there are situated one or more bleed ports 4 which access the partial vacuum pressure at the throat exit; these ports are connected to a vacuum driven power take-off rotor means 5 which is rotated by the vacuum driven flow in through the rotor from the ambient atmosphere to do useful work.

In practice, the choice of average throat speed enhancement will be made by the design engineer, taking into account such things as size and cost, power output desired, electric generator operating characteristics, average wind speed prevailing in the region and so on. Optimization of design in any particular case will be clear to those versed in the art from the above description and the scientific and engineering principles set out.

The whole assemblage can be mounted on a freely turning support, and with an orientation means such as a tail, kept headed properly into the wind at all times.

### Application to Providing Greatly Increased Air Power on Moving Vehicles.

One very valuable version of the invention is that, instead of utilizing the atmospheric wind to furnish the necessary input of mass flow, one can instead use the relative air flow moving past the apparatus of the invention when it is mounted on any moving vehicle as a platform, such as on a locomotive, train, car, truck, airplane, ship, all-terrain vehicle, etc. The inlet air velocities to the nozzle and apparatus involved, when mounted on any moving vehicle, are much larger than those from average wind speeds, so that much larger mass flow rates (dm/dt=m-dot=ρVA) are available to increase its power-output. In this moving platform version of the invention, the output power can readily then be used by the vehicle itself if it is an electric powered vehicle or hybrid powered vehicle, or it can be used to generate rotational energy for other applications. For example an automobile moving at 100 km/hr (27.7 m/s) will deliver a mass flow of 27.7×1.2=33.2 kg/s, through a nozzle cone of inlet area of 1 square meter mounted on the automobile. And, at sonic speed at the nozzle throat, this represents 1.6 megawatts of air power [P=½×33.2×313²=1.6×10⁶ watts]. Clearly the motive power potentialities with my invention are enormous.

The term “wind” is understood to mean any air flow whether of atmospheric wind, relative air flow past a moving vehicle, a convectively moving plume of air, a vortex flow of, etc.

The terms “air flow” or “wind flow” are also understood to mean a flow of any compressible fluid or gas.

Isentropic acceleration of a mass flow of air and lowering of its pressure can also be efficiently accomplished by a vortex flow as well as by a linear acceleration in the De Laval Nozzle of the preferred embodiment; consequently the invention can be practiced by a vortex acceleration means, and also by a combination of a vortex and De Laval Nozzle means.

Also, where I use the term isentropic flow, I intend to include quasi-isentropic flows, that is to say flows in which, because of friction, duct roughness, flow turning, etc. the flow departs from strict or ideal isentropic conditions; I can do this because the amplification in flow velocity caused by the isentropic process in the method of my invention is so large that departures from isentropic flow, even of the magnitude of fifty or more percent, still leave an enhancement of wind power much greater than all conventional methods for wind power extraction.

I note also that under ideal conditions it may be possible to reach supersonic flow velocities in the nozzle, thereby making possible even larger power output.

Design Safety Considerations: Rotor Mechanical Strength. And Noise Hazard

With sonic nozzle flow speeds, the power take-ff means such as a turbine, or rotor typically revolves at very high speeds (e.g. 20,000 to 40,000 rpm or higher) It therefore develops high centrifugal stresses at its rim [Ref. 6] which can cause bursting and disintegration of the entire rotor if critical rotation speeds are reached or exceeded. Such design safety concerns require state of the art knowledge and input from mechanical safety experts.

When operated at sonic speed, the flow may emit a high pitched intense noise which can be damaging to the hearing. Protective earphones can dampen the high noise level. The noise level can also be reduced by insulation and by operating at slightly less than the optimum power or sonic speed.

### REFERENCES

1. Fales, E. N., “Windmills”. Sect. 9-8 in Standard Handbook for Mechanical Engineers, Editors, Baumeister, T and Marks, L. S., McGraw Hill, New York. 7th edition, 1967.
2. Munson, Bruce R., Young, Donald F., and Okiishi, Theodore, H., Fundamentals of Fluid Mechanics, John Wiley & Sons, New York. 1990.
3. Shapiro, Ascher, H., The Dynamics and Thermodynamics of Compressible Fluid Flow, 2 Vols., John Wiley & Sons, New York.1954.
4. R. Courant and K. O. Friedrichs, Supersonic Flow and Shock Waves. Interscience, New York, 1948.
5. This power take-off rotor means is described in the disclosure of U.S. Utility patent application entitled: “Method and apparatus for efficiently generating and extracting power from an air flow to do useful work”. Applicant and Sole Inventor: Bernard A. Power. application Ser. No. 12/927,830. Filing Date Nov. 26, 2010. Confirmation No. 1124.
6. Machinery's Handbook, 27th edition. Industrial Press, Inc., New York. 2004.

The embodiments of the invention in which an exclusive property or privilege is claimed are defined as follows:

1. A method for greatly increasing the power available from an air flow, comprising the steps of, intercepting a mass flow of air, accelerating said mass flow of air by an isentropic process to near sonic speed and greatly lowered static pressure, setting up a subsidiary mass flow of air through a power-take off means, said subsidiary mass flow being driven by the pressure differential between said lowered static pressure and the ambient pressure outside the intake of said power take-off means, said subsidiary mass flow of air producing rotational motion in a rotor in said power take-off means to do useful work

2. A method as in claim 1 wherein said mass flow of air is intercepted from the wind.

3. A method as in claim 1 wherein said mass flow of air is intercepted from the air flowing past a moving vehicular platform on which said method is practiced.

4. A method as in claims 1 to 3 inclusive wherein said acceleration of said mass flow of air is accomplished by means of a De Laval Nozzle.

5. A method as in claims 1 to 3 inclusive wherein said acceleration of said mass flow of air is accomplished by a vortex means.

6. A method as in claims 1 to 3 inclusive wherein said acceleration of said mass flow of air is accomplished by a combination of a vortex means and a De Laval Nozzle means.

7. An apparatus for greatly increasing the power of a mass flow of air and extracting a portion of said increased power, consisting of a De Laval Nozzle and a power take-off means, said nozzle having its inlet converging section and its outlet diverging section attached together at their minimum cross-section areas to form said nozzle's throat section, said power take-off means consisting of a flow reaction rotor attached to said diverging section immediately downstream of said throat by a flow access port; said mass flow of air through said De Laval Nozzle accelerating through said converging nozzle section to reach near sonic speed and reduced pressure in said nozzle throat, said mass flow then decelerating through said diverging nozzle section from near sonic speed to reach ambient wind speed and pressure at said diverging section exit; said reduced air pressure in said nozzle throat also drawing in ambient air through said power take-off port connected to said power take-off rotation means, said inflow of ambient air being accelerated in and through said rotation means, said acceleration flow also being so directed in said rotor as to impart a rotation to said rotation means enabling said power take-off rotation means to do useful work.

8. An apparatus as in claim 7 wherein said mass flow of air is supplied by the wind and the apparatus is kept pointed into said wind flow by a vane orienting means.

9. An apparatus as in claim 7 wherein said apparatus is mounted on a moving vehicle, such as a car, truck, train, ship or airplane, etc,. and the basic mass flow of air into the De Laval Nozzle is then supplied by the relative air flow between the moving vehicle and the ambient atmosphere.

10. An apparatus as in claims 7 to 9 inclusive wherein said acceleration of said mass flow of air is supplied by a vortex flow inducing means instead of a De Laval Nozzle.

11. An apparatus as in claims 7 to 9 inclusive wherein said acceleration of said mass flow of air is supplied by a combination of a vortex flow inducing means and a De Laval Nozzle.
